(19) United States
(12) Patent Application Publication
(10) Pub. No.: US 2013/0062344 A1
(43) Pub. Date: Mar. 14, 2013

(54) PACKAGING BOX AND METHOD FOR FABRICATING THE SAME

(71) Applicants: June-Sop KIM, Seoul (KR); Yeon-Su KIM, Gyeonggi-do (KR); Jin-Hee CHO, Seoul (KR)

(72) Inventors: June-Sop KIM, Seoul (KR); Yeon-Su KIM, Gyeonggi-do (KR); Jin-Hee CHO, Seoul (KR)

(73) Assignee: Samsung Electronics Co., LTD., Gyeonggi-Do (KR)

(21) Appl. No.: 13/588,377

(22) Filed: Aug. 17, 2012

(30) Foreign Application Priority Data
Sep. 8, 2011 (KR) 10-2011-0091098

(51) Int. Cl. B65D 5/42; B65D 85/00; B31F 5/02

(52) U.S. Cl. 220/62.2; 156/211; 220/660; 206/320

(57) ABSTRACT

A packaging box and a method for fabricating the packaging box are provided that reduces a defective fabrication rate from reduced wrinkling and cracks. A V-shaped cut groove is formed to extend in one direction by cutting an outer surface of an inner layer, a curved groove having a curved surface is formed to extend in parallel with the cut groove by pressing an inner surface of the inner layer, and the inner layer is bent with respect to the curved groove. The curved groove is at an offset position with respect to the cut groove.

### CLAIM OF PRIORITY

This application claims priority under 35 U.S.C. §119(a) from a Korean Patent Application filed in the Korean Intellectual Property Office on Sep. 8, 2011 and assigned Serial No. 10-2011-0091098, the contents of which are incorporated herein by reference in its entirety.

### BACKGROUND OF THE INVENTION

1. Field of the Invention

The present invention relates to electronic product packaging. , More particularly, the present invention is related to a paper packaging box and a method for fabricating the same.

2. Description of the Related Art

In general, after industrial products are packaged in boxes, they go out to the market. Various types of electronic products, for example, home appliances such as portable terminals, computers and TVs are packaged mainly in paper boxes (e.g. cardboard). These electronic products are primarily wrapped with a cushioning material and secondarily packaged.

A small-size device such as a portable terminal includes a number of components such as a device body, a battery pack, a battery cover, a battery charging cradle, cables, and a manual. To prevent these components from being damaged by shaking/shifting inside a package, the components are wrapped fixedly in an inner package and then in an outer package.

FIGS. 1, 2 and 3 sequentially illustrate a conventional operation for fabricating a packaging box. In FIGS. 1, 2 and 3, reference numeral 10 denotes an inner layer of a packaging box and reference numeral denotes an outer layer of the packaging box. The inner and outer layers 10 and may be formed of paper.

To fabricate such a packaging box, the inner and outer layers 10 and 20 are fabricated by cutting a base paper to predetermined dimensions and then bent at the cut, to thereby package the components of an electronic product. FIGS. 1 and 2 illustrate an operation for bending the fabricated inner layer 10. To secure the components of an electronic product without having the components shift or shake, the inner layer 10 is as thick as or thicker than a predetermined value. If the inner layer 10 is simply bent, it may suffer cracks on its outer surface or wrinkles on its inner surface. Therefore, a cut groove 11 is cut on the outer surface of the inner layer 10 and bent so that the cut groove 11 is positioned at a corner of the inner layer 10. In this manner, even though the inner layer 10 is bent, generation of cracks or wrinkles on the surfaces of the inner layer 10 at its corners can be suppressed.

FIG. 3 illustrates the outer layer that surrounds the inner layer 10. As the inner layer 10 is surrounded by the outer layer 20, a packaging box is actually in finished form at this stage. Since the cut groove 11 is cut on the outer surface of the inner layer 10, and the inner layer 10 is bent so that the cut groove 11 is positioned at a corner, the inner layer 10 has grooves at its corners and “curved corners” 21a of the outer layer are curved in the outer appearance of the packaging box.

If the corners of the packaging box are curved as described above, it is difficult to maintain individual packaging boxes in the same shape in view of the nature of paper. As a result, the individual packaging boxes may not have uniform quality.

To avert this problem, an interposing layer (shown in FIG. 4) is inserted or attached between the inner and outer layers 10 and so that the corners 21b of the outer surface of the outer layer are maintained at a predetermined angle, preferably two outer surfaces forming each corner is maintained at 90 degrees.

However, the use of an interposing layer in a packaging box makes box fabrication complicated and increases fabrication cost such as material cost.

### SUMMARY OF THE INVENTION

An exemplary aspect of the present invention is to address at least some of the problems and/or disadvantages and to provide at least some of the advantages described below. Accordingly, an aspect of the present invention is to provide a packaging box having a structure that facilitates fabrication of individual packaging boxes in the same shape and thus with a uniform quality, and a method for fabricating the same. The presently claimed invention advantageously also reduces the shaking and shifting of components shipped within the packaging box.

Another exemplary aspect of the present invention is to provide a packaging box having a structure that facilitates fabrication and reduces fabrication cost, and a method for fabricating the same.

In accordance with an exemplary embodiment of the present invention, there is provided a method for fabricating the packaging box in which a V-shaped cut groove is formed to extend in one direction by cutting an outer surface of an inner layer, and a curved groove having a curved surface is formed to be extended in parallel with the cut groove by pressing an inner surface of the inner layer, and the inner layer is bent with respect to the curved groove. The curved groove is at an offset position with respect to the cut groove.

In accordance with another exemplary embodiment of the present invention, there is provided a packaging box including an inner layer. The inner layer has a cut groove on an outer surface of the inner layer and a curved groove on an inner surface of the inner layer. The cut groove is formed by cutting the outer surface of the inner layer so that the curved groove is formed at an offset position with respect to the cut groove by pressing the inner surface of the inner layer, and the inner layer is bent with respect to the curved groove.

### BRIEF DESCRIPTION OF THE DRAWINGS

The above and other exemplary objects, features and advantages of certain exemplary embodiments of the present invention presented herein will become more apparent to a person of ordinary skill in the art from the following detailed description taken in conjunction with the accompanying drawings, in which:

FIGS. 1, 2 and 3 sequentially illustrate an operation for fabricating a conventional box used for shipping packages;

FIG. 4 illustrates another type of conventional box used for shipping packages; and

FIGS. 5 to 8 sequentially illustrate an operation for fabricating a box having a structure according to an exemplary embodiment of the present invention.

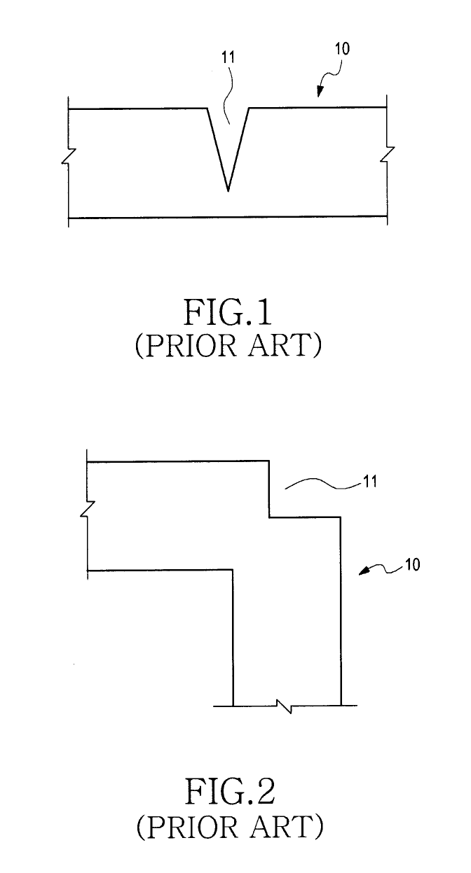

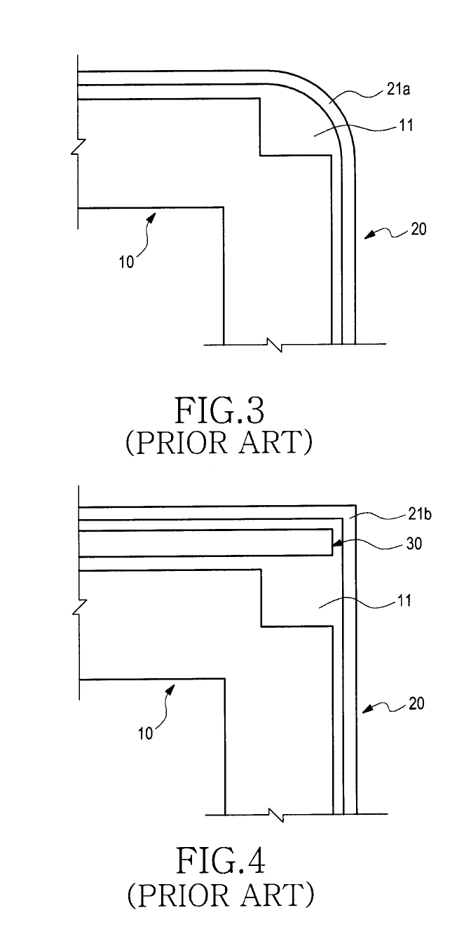

Throughout the drawings, the same drawing reference numerals will be understood to refer to the same elements, features and structures.

### DETAILED DESCRIPTION

Reference will now be made to preferred exemplary embodiments of the present invention with reference to the attached drawings. A detailed description of well-known functions and structures of may be omitted if its inclusion would be deemed to obscure appreciation of the subject matter of the present invention by a person of ordinary skill in the art.

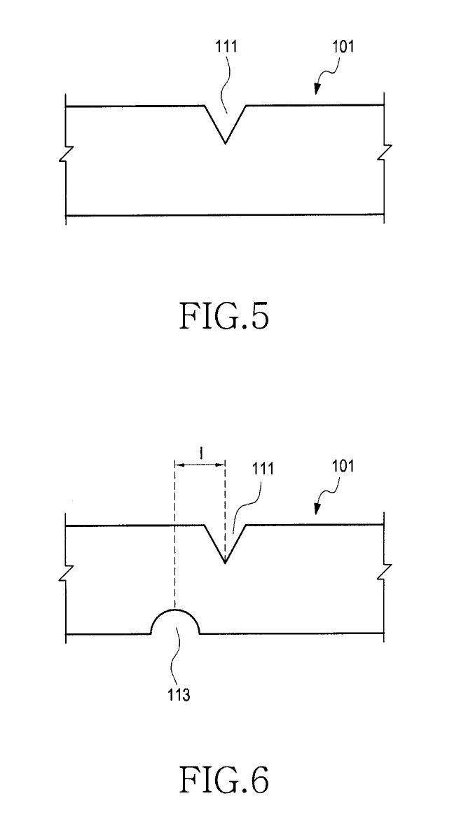

FIGS. 5 to 8 sequentially illustrate an exemplary operation for fabricating a packaging box 100 according to an exemplary embodiment of the present invention.

With reference beginning at FIG. 5, in an exemplary method for fabricating the packaging box 100 according to the present invention, a cut groove 111 is formed on an outer surface of an inner layer 101 and a curved groove 113 is formed on an inner surface of the inner layer 111. More specifically, the cut groove 111 and the curved groove 113 are intentionally misaligned with a predetermined gap “I” between them. In other words, the cut groove 111 and the curved groove 113 are formed at positions misaligned with respect to a direction perpendicular to the inner or outer surface of the inner layer 101 and then the inner layer 101 is bent with respect to the bent groove 113.

Referring now to FIG. 6, it is noted that the cut groove 111 and the curved groove 113 are misaligned vertically, apart from each other by the predetermined gap I.

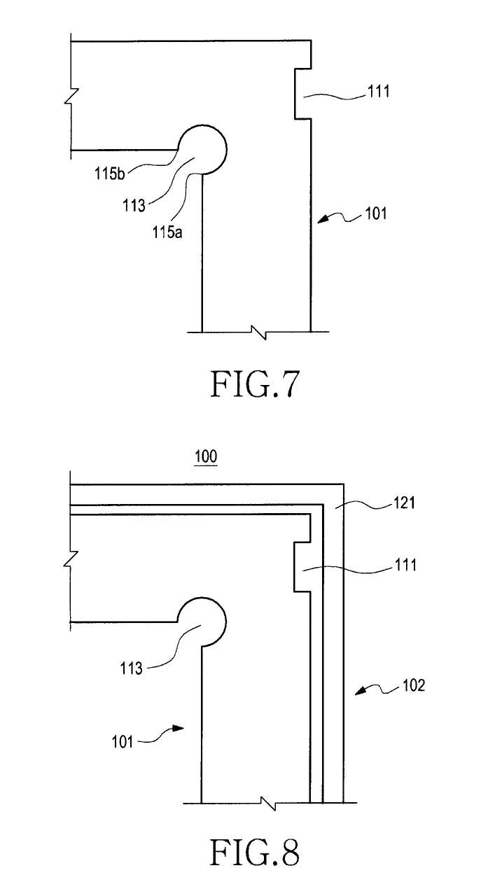

With reference to FIGS. 6 and 7, due to the misalignment between the cut groove 111 and the curved groove 113, when the inner layer 101 is bent with respect to the curved groove 113 as part of the assembly, the cut groove 111 is positioned at a side of a corner of the outer surface of the inner layer 101. On the other hand, since the inner layer 101 is bent with respect to the curved groove 113, the curved groove 113 is positioned at a corner of the inner surface of the inner layer 101.

FIG. 5 illustrates the cut groove 111 formed by cutting or removing a part of the inner layer 101 from the outer surface of the inner layer 101 formed by cutting a base paper. The cut groove 111 is extended along one direction on the outer surface of the inner layer 101, with its section shaped into “V”. Without the cut groove 111, tension is applied to the outer surface of the inner layer 101 when the inner layer 101 is bent. As a result, the outer surface of the inner layer 101 may have cracks. The use of the cut groove 111 suppresses tension generated when the inner layer 101 is bent, thus preventing cracks.

FIG. 6 illustrates the curved groove 113 formed on a surface of the inner layer 101 where cut groove 111 is formed. More particularly, the curved groove 113 is formed at the surface of the inner layer 101 opposite to the surface on which the cut groove 111 is formed. The curved groove 113 extends in parallel with the cut groove 111, with its section shaped into a semi-circle or a similar form. The curved groove 113 is preferably formed by pressing the inner surface of the inner layer 101, rather than by cutting the inner surface of the inner layer 101. However, it is also possible, for example that the curved groove could be formed via a number of ways to cut the base paper, such as stamped, etc. The curved groove 113 extends in parallel with the cut groove 111, at an offset position from the cut groove 111. In other words, the curved groove 113 is misaligned with the cut groove 111 with respect to a direction perpendicular to the inner or outer surface of the inner layer 101. The use of the curved groove 113 suppresses wrinkles that may be produced on the inner surface of the inner layer 101, when the inner layer 101 is bent.

The outer surface of the inner layer 101 is bent with respect to the curved groove 113. FIG. 7 illustrates the inner layer 101 in a bent state. When the inner layer 101 is bent with respect to the curved groove 113, the cut groove 113 is positioned at a side of a corner (i.e. adjacent the corner) resulting from bending the inner layer 101. It can also be seen that the edges 115a, 115b of the curved groove are closer to each other after the inner layer 101 is bent. Accordingly, as shown in FIG. 8, a corner 121 formed by bending the inner layer can be maintained in an angled shape on the outer surface of the inner layer 101. Considering that a packaging box is normally in a finished form in a regular hexahedron or rectangular parallelepiped shape, two outer surfaces forming a corner resulting from bending the inner layer 101 is substantially at 90 degrees.

A person of ordinary skill in the art should understand and appreciate from the current description that in the above procedure that are embodied in the presently claimed invention from cutting the inner layer to bending the inner layer, the cut groove 111 and the curved groove 113 may be sequentially formed or in a reverse order. In addition, the cut groove 111 and the curved groove 113 may be formed simultaneously. When the inner layer is cut and bent as described above, a bent length or position may vary depending on the components of a product to be packaged.

FIG. 8 illustrates an outer layer 102 surrounding the inner layer 101. As the inner layer 101 is surrounded by the outer layer 102, the packaging box 100 is actually finished. Since a corner of the outer surface of the inner layer 101 is angular, for example, two outer surfaces forming a corner are at 90 degrees, a corner 121 of the outer layer 102 is maintained in an angular shape. Meanwhile, the outer surface of the inner layer 101 may be attached onto the inner surface of the outer layer 102.

In this manner, as the curved groove 113 and the cut groove 111 are formed respectively on the inner and outer surfaces of the inner layer 101 in the packaging box 100 so that the curved 113 and the cut groove 111 are misaligned, the outer and inner surfaces of the inner layer 101 can be protected against cracks and wrinkles, respectively when the inner layer 101 is bent to formed the finished product. Since the corners of the inner layer 101 resulting from bending the inner layer 101 are maintained angular, the corners of the packaging box 102 finished by surrounding the inner layer 101 with the outer layer 102, specifically the corners 121 of the outer layer 102 can be maintained angular, without the need for using an additional interposing layer.

As is apparent from the above description of the packaging box and the method for fabricating the same according to the present invention, the corners of the packaging box are made angular, thereby enabling individual packaging boxes in the same shape. In addition, when an additional interposed layer is used, the fabrication tolerances or working deviations of an inner layer, the interposed layer, and an outer layer are likely to lead to fabrication of a defective packaging box. However, because the packaging box of the present invention has only an inner layer and an outer layer, the resulting reduction of material cost and failure rate can decrease fabrication cost.

While the present invention has been particularly shown and described with reference to embodiments thereof, it will be understood by those of ordinary skill in the art that various changes in form and details may be made therein without departing from the spirit and scope of the present invention as defined by the following claims For example, while the V-shaped groove is preferred, the other shapes could be used such as substantially L-shaped or U-shaped, or any other shape groove so as to form a substantially perpendicular shape after the inner layer is bent. Also, the curved groove could have a shape that is less substantially circular than shown and described. The base paper may comprise cardboard or other suitable materials capable of being bent as shown in the drawings without being deformed so as to render the packaging box inoperable for its intended use after construction.

What is claimed is:

1. A method for fabricating a packaging box, comprising:
forming a cut groove that extends in one direction by cutting an outer surface of an inner layer of a base paper for a box;
forming a curved groove having a curved surface that extends in parallel with the cut groove by pressing an inner surface of the inner layer of the base paper; and
bending the inner layer with respect to the curved groove,
wherein the curved groove is formed at an offset position with respect to the cut groove.

2. The method of claim 1, wherein the cut groove is V-shaped.

3. The method of claim 1, wherein the cut groove is shaped to form a substantially perpendicular shape after the inner layer is bent.

4. The method of claim 1, wherein after the inner layer is bent, the curved groove is positioned at a corner of the inner surface of the inner layer formed from bending the inner layer, and wherein the cut groove is positioned adjacent a corner of the outer surface of the inner layer formed from bending the inner layer with respect to the curved groove.

5. The method of claim 1, wherein a corner of the outer surface of the inner layer formed from bending the inner layer with respect to the curved groove is formed into an angular shape.

6. The method of claim 1, wherein two outer surfaces forming a corner by bending the inner layer with respect to the curved groove are substantially at 90 degrees.

7. The method of claim 1, further comprising surrounding the outer surface of the inner layer of the base paper with an outer layer of the packaging box.

8. The method of claim 1, further comprising:
surrounding the outer surface of the bent inner layer with an outer layer of the packaging box; and
attaching the outer surface of the inner layer of the base paper to an inner surface of the outer layer of the packaging box.

9. The method of claim 8, wherein after the inner layer is bent, the curved groove is positioned at a corner of the inner surface of the inner layer formed from bending the inner layer with respect to the curved groove, and the cut groove is positioned adjacent a corner of the outer surface of the inner layer from bending the inner layer.

10. The method of claim 8, wherein a corner of the outer surface of the inner layer formed from bending the inner layer with respect to the curved groove is formed into an angular shape.

11. The method of claim 8, wherein two outer surfaces forming a corner by bending the inner layer with respect to the curved groove are substantially at 90 degrees.

12. A packaging box comprising:
an inner layer of a base paper having a cut groove on an outer surface of the inner layer and a curved groove on an inner surface of the inner layer of the base paper,
wherein the cut groove is cut from the outer surface of the inner layer, and the curved groove is formed in the base paper at an offset position with respect to the cut groove by pressing the inner surface of the inner layer of the base paper, and the inner layer is bent with respect to the curved groove.

13. The packaging box of claim 12, wherein the cut groove is V-shaped and extends in one direction on the outer surface of the inner layer of the base paper, and the curved groove has a curved surface that extends in parallel with the cut groove on the inner surface of the inner layer.

14. The packaging box of claim 12, wherein a corner is formed from the inner layer of the base paper being bent with respect to the curved groove and the cut groove is positioned on the outer surface of the inner layer, in parallel with a side of the corner.

15. The packaging box of claim 14, wherein two outer surfaces forming the corner are substantially at 90 degrees.

16. The packaging box of claim 12, further comprising an outer layer of the base paper substantially surrounding the outer surface of the inner layer.

17. The packaging box of claim 16, wherein the outer surface of the inner layer is attached to an inner surface of the outer layer.

18. The packaging box of claim 17 being sized to hold a portable terminal or tablet computer.
